(19) United States
(12) Patent Application Publication
(10) Pub. No.: US 2026/0318671 A1
(43) Pub. Date: Oct. 15, 2026

(54) Doppler Effect Based System and Method of Measuring On-Axis of Surface Movement

(71) Applicant: Measure-IPR ApS, Roskilde (DK)

(72) Inventors: KÅRE SLOTH JENSEN, Frederiksberg (DK); HØI LASSE, Helsinge (DK); MICHAEL LINDE JAKOBSEN, Roskilde (DK); VAGN STEEN GRUNER HANSON, Fakse (DK)

(21) Appl. No.: 19/105,476

(22) PCT Filed: Aug. 10, 2023
(86) PCT No.: PCT/IB2023/058084

§ 371 Date: Feb. 21, 2025

(30) Foreign Application Priority Data
Aug. 24, 2022 (DK) PA202200784

(51) Int. Cl. G01B 9/02; G01B 11/26

(52) U.S. Cl. CPC G01B 9/02045; G01B 11/26

(57) ABSTRACT

A system and method for optically measuring divergence of a surface in an axial direction at an angle with respect to the surface. The optical system comprising a laser source and a detector. A laser beam of coherent light is emitted from the laser source of the optical system in the axial direction towards said surface while the surface is moving in a transversal direction relative to the emitted laser beam either because the system is mounted on a moving object such as a truck or the surface may move, e.g. being a conveyor belt. The laser beam is emitted such that the 1/e² beam radius on the surface is larger than or equal to Formula I wherein λ is the wavelength of the emitted laser beam and L is the distance from the laser source to said surface. The detector is used to measure an optical signal of a reflected beam reflected from the surface and the Doppler frequency of the reflected beam is determined. Based on the Doppler frequency the movement of the surface in said axial direction is determined.

### TECHNICAL FIELD

The present invention relates to the field of deflectometry and divergence of surface placement in particular non-contact deflectometry based on Doppler shift measurements.

### BACKGROUND OF THE INVENTION

Measurement of the deflection of surfaces under the force of a predetermined load is known to be useful for the determination of properties of that surface, such as carrying capacity, durability, wear and even the material integrity of the foundation.

One known way to determine the deflection of a surface moving relative to the deflectometer is by detection of the Doppler shift of coherent light reflected off of the deflected surface.

Doppler based deflectometry has several benefits. One such benefit is that the measurements are contactless, i.e. based on the light reflection. Another benefit is that measurement is performed while the deflectometer, the surface or both are in movement, hence it is not necessary to completely pause operation of a system to take the measurements. For example if the surface to be measured is a road, it is not necessary to block that road and stop traffic to make the measurement, as the deflectometer can be located on a vehicle, or if the surface to be detected is a conveyor belt it is not necessary to stop the conveying while the measurement is taken.

However, the underlying principle of the high sensitivity to small changes in the distance between the sensor and the surface also makes such Doppler based deflectometers highly sensitive to speckle decorrelation on optically rough surfaces and to dirt on the surface to be measured, such as sand and gravel on a road, or structuring of a conveyor belt to provide increased friction. Such speckle decorrelation causes fluctuations in the signal which are indicative of other features than the deflection to be measured. A suggested solution to this issue is receiver diversification that enables the system carrying the deflectometer to maintain a constant distance to the surface to be detected. Such compensations for the speckle decorrelation are technically complicated and expensive.

### SUMMARY OF THE INVENTION

Numerous objects and advantages, which will be evident from the description of the present invention, are according to a first aspect of the present invention obtained by:

A method for optically measuring divergence of a surface in an axial direction at an angle with respect to said surface, said method comprising:
providing an optical system, said optical system comprising a laser source and a detector;
emitting a laser beam of coherent light from said laser source of said optical system in said axial direction towards said surface while said surface is moving in a transversal direction relative to said emitted laser beam;
said laser beam emitted such that the beam radius on said surface is larger than or equal to

$$\sqrt{L \frac{L}{π}}$$

wherein λ is the wavelength of the emitted laser beam and L is the distance from the laser source to said surface such as the beam radius on said surface being within a range of

$$\sqrt{L \frac{L}{π}}$$

to 5 times

$$\sqrt{L \frac{L}{π}} ;$$

measuring an optical signal of a reflected beam reflected from said surface; determining the Doppler frequency of the reflected beam;
based on the Doppler frequency determining the movement of said surface in said axial direction.

By an axial direction is understood a first direction that will intersect with the surface the divergence of which surface and underlying material is to be measured. By the divergence is understood the dynamically change in distance between the detector and the surface, e.g. due to a deflection under an applied force or due to vibrations. The optical system will be located a distance L from the surface along the axial direction. The coherent light emitted from the laser source will be emitted in the axial direction. In some variants, the optical system may be arranged such that the axial direction is substantially perpendicular to the surface such as 0-10 degrees from perpendicular, typically 0 to 2 degrees from perpendicular. In some variants, the optical system may be arranged such that the axial direction is at an angle ranging from 30 to 150 degrees with respect to the surface. In some variants, the angle between the optical system and the surface may vary during the time in which measurements are performed. For example if variation in distance between the surface and the optical system is measured due to the deflection of the surface, a load which is causing the deflection of the surface may also cause the angle to change. The angle may also change due to the relative movement of the optical system and the surface as unevenness of the surface may cause variation in the angle depending on the relative position at the time of measurement.

The force causing divergence in the surface and underlying material, e.g. an applied force, must move relative to the surface in a transverse direction for any velocity in the axial direction to occur, as the axial velocity depends on how much the material under the surface is affected by the deflection force. Alternative, a standing wave or a vibration through the material may produce the axial velocity. For example a deflection means, i.e. a means for applying a deflection force, may be mounted along with the optical system, such that the optical system and the deflection force move together relative to the surface, such that the axial velocity varies in response to the constant deflection force as the material is deflected to a varying degree depending on the structural strength of the material. In variants where a means for applying the deflection force is mounted fixedly relative to the optical system, the force causing divergence and the optical system will be moving together in a transverse direction relative to the surface.

Knowing the distance of the relative movement in the transverse direction allows correlating the measured Doppler shift with a position on the surface, e.g. to determine where the strength of the material is weakened such that the deflection force causes greater axial velocity than where the material is strong.

Measuring the reflected beam in the axial direction, i.e. on the axis with the emitted laser beam, causes interference between the emitted coherent laser beam and the Doppler shifted reflected beam. This interference pattern may be measured by the detector and from such measurements the relative velocity between the optical system and the surface may be determined. It is to be understood that while it is the reflection from the surface which is being measured and thus the beam width at the intersection with the surface which is of importance, the measurements relate to the properties of the underlying structure, e.g. material integrity and how much the material can give way under the applied deflection force rather than to surface structure.

Coaxial measurement of the reflection, i.e. the coherent laser beam and the reflected beam being coaxial, is preferable as measurements are simplified. It is, however, to be understood that in other variants the system may be configured to measure a reflected beam which is not coaxial with the emitted coherent laser beam, e.g. by having the reflected beam collected at an angle or guided to the detector via a separate path. The benefits of the optimised beam width are not limited to coaxial measurement.

By the optical system being adapted to provide a laser beam with a beam radius falling within a certain range, is understood that the arrangement of the components of the optical system is such that at the distance L, the beam radius of a Gaussian beam emitted from a laser source of the optical system will fall within that range where the optical intensity drops to 1/e². In other words, the beam radius of the invention is determined according to the Gaussian beam radius standard and is the radius at which the intensity of the Gaussian beam has decreased to 1/e² from the maximum intensity at the beam central axis. This is the case for both circular and elliptical beam profiles such that for elliptical beam profiles at least one of the long or the short radius fulfil the requirements of the beam radius. For example, for an elliptical beam the large radius may fulfil the requirement while the small radius is significantly smaller, which has the benefit of delivering high power of the reflected laser light due to the small radius while obtaining the benefits of a wide beam according to the invention. Such arrangement may arise from a combination of choice of laser source, guiding means in the optical paths, such as optical fibres, as well as the choice of one or more lenses and their relative distance for shaping the laser beam. The skilled person will appreciate that several combinations can be chosen, which will all lead to the beam radius according to the invention, e.g. by placing multiple lenses in sequence.

Increasing the beam radius is beneficial to minimise adverse effects from speckle decorrelation. Meanwhile decreasing the beam radius is beneficial as it increases the power of the reflected beam which in turn increases the measurement accuracy. The beam radius on the surface being larger than or equal to

$$\sqrt{L \frac{L}{π}}$$

wherein λ is the wavelength of the emitted laser beam and L is the distance from the laser source to said surface, which ensures that the adverse effects of speckle decorrelation are reduced and reliable measurements can be achieved. To strike a balance between the opposing concerns of speckle decorrelation and power of the reflected beam to be detected, the beam radius is preferably within a range of

$$\sqrt{L \frac{L}{π}}$$

to 5 times

$$\sqrt{λ \frac{L}{π}}$$

wherein λ is the wavelength of the emitted laser beam and L is the distance from the laser source to said surface. In a preferred variant, the beam radius will be within the range of 1 to 3.5 times

$$\sqrt{λ \frac{L}{π}} .$$

In a yet more preferred variant the radius will be within the range of 1 to 2.3 times

$$\sqrt{λ \frac{L}{π}} ,$$

such as within 1.4 to 1.9 times

$$\sqrt{λ \frac{L}{π}} .$$

According to a further embodiment of the first aspect of the invention, the distance said optical system has travelled in the transverse direction relative to said surface and/or the speed of the relative transverse movement is monitored.

In some variants the optical system is mounted along with means for applying a deflecting force for providing a divergence of the surface to form a combined system. In such variants, monitoring the distance the combined system has travelled in the transverse direction relative to the surface enables the correlation between a measured Doppler frequency and the position of the surface corresponding to that measurement. The distance travelled may for example be measured by wheel sensors accurately determining the distance based on rotations. In other variants the relative speed of movement in the transverse direction may be monitored and used to determine the distance travelled during the measurement time to correlate the position between the points of measured Doppler frequency and the position on the surface corresponding to the measurement.

According to a further embodiment of the first aspect of the invention, the relative movement between the surface and the optical system is due to the movement of a vehicle onto which the optical system is mounted along the surface.

Having the optical system mounted on a vehicle that can be self-propelled, has the benefit of making the optical system movable and thus easy to use while in motion, e.g. for measuring roads. In other variants, the optical system may be mounted separately from a vehicle, e.g. on a trailer which can be hauled by a separate vehicle.

The vehicle or the trailer on which the optical system is mounted may also comprise assistive equipment, such as a load, which can be applied to the surface and cause deflection while that deflection is being measured by the optical system. The load may be adjustable or fixed.

According to a further embodiment of the first aspect of the invention, the relative movement between the surface and the optical system depends on the translation and/or rotation of the surface while the optical system is static.

Mounting the optical system statically is beneficial for surfaces which are arranged to move, e.g. conveyor belts or moving parts in machinery, e.g. rotating parts, where the surface to be detected is moving on its own. In such systems the stability or wear of the moving parts may be monitored by a statically mounted optical system. For example, if the measured Doppler shift exceeds a certain threshold it may be indicative of a part being worn or mounted askew.

According to a further embodiment of the first aspect of the invention, measurement results are transmitted to a data processing unit for storing and/or processing.

Transmitting the measurement results to an external data processing unit has several benefits. It may allow the optical units to be smaller, as they need less on board processing power. Furthermore, the external data processing unit may receive data from multiple optical systems allowing for central mapping of a surface and/or calibration of one or more optical systems based on a reference optical system which also transmits measurement data to the external data processing unit. The external data processing unit may also contain data from previous measurements of the surface making it possible to compare and monitor changes over time, e.g. due to wear.

Another object of the present invention is to provide an optical system for use in the previously described method.

According to a second aspect of the present invention, the above objects and advantages are obtained by:

An optical system for use in a method of measuring surface divergence according to the method of the invention, said optical system comprising
a laser source for emitting coherent light,
a first optical path being arranged to guide coherent light from said laser source and for directing a coherent laser beam towards a surface, said first optical path being polarization maintaining,
a detector, for detecting a reflected beam of light reflected off of said surface,
a second optical path for collecting and guiding said reflected beam to said detector, said second optical path being polarization maintaining,
a polarizing beam splitter arranged between said first optical path and said second optical path for diverting the on-axis reflected beam to said second optical path,
said optical system providing said laser beam with a beam radius being larger than or equal to

$$\sqrt{λ \frac{L}{π}}$$

at the intersection with said surface, such as the beam radius being within a range of

$$\sqrt{λ \frac{L}{π}}$$

to 5 times

$$\sqrt{λ \frac{L}{π}} .$$

By a laser source is understood any source which is configured to emit coherent light, i.e. laser light. It may be any known laser source, such as but not limited to gas lasers, solid-state lasers, fibre lasers, dye lasers or laser diodes.

In some variants the laser source may be emitting coherent light with a wavelength in the range of 1000 nm to 3000 nm such as within the wavelength range of 1400 nm to 2000 nm such as 1500 nm to 1600 nm, typically at 1550 nm due to the availability of suitable lasers at this wavelength making it a cost beneficial solution.

The detector is adapted to take measurements which are correlated to the axial velocity between the optical system and the surface which it is used to measure. In some variants, the detector may be measuring the intensity of the reflected beam of light reflected off of the surface, hence making it possible to determine the interference pattern and measure the Doppler frequency.

In some preferred variants the optical system further comprises a bypass optical path arranged to guide a subpart of the emitted coherent light from said laser source directly to said detector.

Having a bypass optical path enables a broader range of detectors to be used in the optical system, as the light guided directly from the laser source may then interfere with the reflected light within the detector.

In such preferred variants having the optical system comprise a bypass optical path, an acousto-optic modulator (AOM) is arranged in the bypass optical path. Such an AOM allows the shifting of the frequency of the emitted laser light.

By a first optical path and a second optical path are understood any means of directing the light to and from the components of the optical system in accordance with the invention. For example, an optical path may comprise optical fibres, free space paths directed by lens systems and/or other waveguides. In some variants, all optical paths may be of the same type, e.g. all optical paths may be based on optical fibres, while in other variants the first optical path, the second optical path and/or the bypass optical path may be of one or more different types.

Having the first optical path and the second optical path comprise optical fibres makes it possible to vary the arrangement of the laser source and the detector relative to each other in the construction of the optical system. By having the first optical path and the second optical path be polarization maintaining, it is possible to use a polarising beam splitter to divide the emitted laser beam and the reflected beam and control that the reflected light is being directed to the detector. This in turn enables the on-axis collection of the reflected beam, i.e. the emitted and the reflected beam coincide between the surface and the polarizing beam splitter.

According to a further embodiment of the second aspect of the invention, comprising a lens system for controlling the shape of said emitted laser beam such that said beam radius at the intersection of said laser beam and said surface is larger than or equal to

$$\sqrt{λ \frac{L}{π}} ,$$

such as the beam radius being within a range of

$$\sqrt{λ \frac{L}{π}}$$

to 5 times

$$\sqrt{λ \frac{L}{π}} ,$$

The lens system may comprise one or more lenses arranged to provide a beam radius being larger than or equal to (λL/π)^{1/2} such as falling within the range of (λ L/π)^{1/2} to 5 times (λL/π)^{1/2}. Note that for the context of this application, the beam radius refers to the 1/e² intensity beam radius of a Gaussian beam emitted from a coherent laser source, which may have a circular or an elliptical beam profile.

It is to be understood that the specific choice of number of lenses, types of lenses and distances between lenses is interrelated and also depends on the choice of lasers and fibre. It will be known to the skilled person how the choice of lenses, e.g. choice of concave and/or convex lenses, spherical or aspherical lenses and their curvature will affect the focal length and beam radius.

In preferred variants the lens system is arranged between the beam splitter and the surface. In such variants the lens system may preferably comprise two lenses.

In other preferred variants, lenses of the lens system may be arranged between the first optical path and the beam splitter as well as between the second optical path and the beam splitter. In yet other preferred variants, lenses of the lens system may be arranged both before and after the beam splitter, e.g. between the laser source and the beam splitter and/or between the detector and the beam splitter as well as between the beam splitter and the surface.

In some variants, the lenses of the lens system are mounted such that their relative distance can be varied, thereby enabling adjustment of the lens system to accommodate the use of the same optical system in differing contexts where the distance L to the surface varies.

In some variants, the optical system may be made without a lens system. The intended beam width may then be obtained based on the beam width emitted from the laser source and placement of the laser source relative to the surface to be measured.

According to a second aspect of the present invention, the above objects and advantages are obtained by:

An optical system for use in a method of measuring surface divergence according to the method of the invention, said optical system comprising
a laser source for emitting coherent light,
a detector, for detecting a reflected beam of light reflected of a surface,
a first optical path being arranged to guide coherent light from said laser source and for directing a coherent laser beam towards said surface,
a second optical path for collecting and guiding said reflected beam to said detector,
a circulator arranged between said laser source, said detector, and said surface for keeping said emitted coherent light and said collected reflected beam separate; and
said optical system providing said laser beam with a beam radius being larger than or equal to

$$\sqrt{λ \frac{L}{π}}$$

at the intersection with said surface, such as the beam radius than or equal to being within a range of

$$\sqrt{λ \frac{L}{π}}$$

to 5 times

$$\sqrt{λ \frac{L}{π}} .$$

It is to be understood that the laser source and detector may be of the same type as for the previously described embodiment of the optical system.

In this embodiment due to the presence of an optical circulator it is possible to use optical fibres which may be but do not need to be polarization maintaining, while still enabling the on-axis emission and collection of the reflected beam. The circulator makes it possible to transmit the emitted coherent laser light from the laser source and collect the reflected beam via the same first optical fibre.

In some variants, the optical system may be made without a lens system. The intended beam width may then be obtained based on the beam width emitted from the laser source and placement of the laser source relative to the surface to be measured.

In some preferred variants, the optical system further comprises a bypass optical path arranged to guide a subpart of the emitted coherent light from said laser source directly to said detector.

Having a bypass optical path enables a broader range of detectors to be used in the optical system, as the light guided directly from the laser source may then interfere with the reflected light within the detector.

In such preferred variants having the optical system comprise a bypass optical path, an acousto-optic modulator (AOM) is arranged in the bypass optical path. Such an AOM allows the shifting of the frequency of the emitted laser light.

According to a further embodiment of the second aspect of the invention, the optical system comprises a lens system for controlling the focal point of said emitted laser beam such that said beam radius at the intersection of said laser beam and said surface is larger than or equal to

$$\sqrt{λ \frac{L}{π}} ,$$

such as the beam radius being within a range of

$$\sqrt{λ \frac{L}{π}}$$

to 5 times

$$\sqrt{λ \frac{L}{π} .}$$

In variants having a lens system present, the components are preferably arranged such that the laser source supplies coherent light into a first port of the circulator, the lens system is arranged after the second port of the circulator and the detector is arranged after a third port of the circulator. In some variants a polarizer may be arranged between the third port and the detector.

According to a third aspect of the present invention, the above objects and advantages are obtained by:

A measurement system for use in a method of measuring surface, the measurement system comprising a plurality of optical systems. The plurality of optical systems being arranged along a mounting bar.

By having a measurement system comprising a plurality of optical systems it is possible to measure the axial velocity between each of the optical systems within the plurality of optical systems relative to the surface. Thus, it becomes possible to determine the dynamic topology of the surface at multiple positions by relating to the transversal velocity of the relative movement of the optical system and the surface. For example, multiple optical systems may be placed in an arrangement parallel to the direction of the transverse relative movement of the optical systems and the surface, thus making it possible to map out a wider range of the surface for a single pass. For example this can allow the mapping of a curvature of the surface due to an applied deflection force or a standing wave through the material underlying the surface. In other variants, a plurality of optical systems may be arranged perpendicular to the direction of the transverse relative movement of the optical systems and the surface either instead of or in addition to arrangement in the parallel direction. This could for example allow detection across the width of a conveyor belt. Alternatively or in addition the use of multiple optical systems can also enable verification by having multiple optical systems detect the same surface in short succession. Yet another use of multiple optical systems is the placement of one or more of those optical systems in a region where little wear is expected or where no force is applied such that no deflection is expected in that region, allowing those optical systems to function as reference systems for calibration.

Using a mounting bar for the placement of the plurality of optical systems is beneficial as it enables the fixing of the position of the optical systems within the measurement system relative to each other. For example the optical systems may be mounted at the same distance to the surface to be measured at different positions in relation to the transverse relative movement of the surface. By the same distance is to be understood if the surface to be measured was plane, e.g. the same distance to the expected plane of the surface or to an average distance.

The choice of material for the mounting bar is important to ensure the sturdiness of the mounting bar. This in turn is important to ensure that the axial movement of the surface relative to the optical systems is due to divergence of the surface rather than due to the position of the mounting of an optical system changing over time. During operation of the measurement system, the surrounding environment may cause heating of the mounting bar on which the optical systems are arranged; this is in particular problematic if the mounting bar is not heated uniformly, e.g. if the side facing the object to which the mounting bar is fastened becomes warmer than the side facing the surface on which is being measured or vice versa. Depending on the material such uneven heating may cause the mounting bar to expand and/or bend which will move the optical systems compared to their position for the un-heated bar, i.e. the bar before measurements were taken. Bending would also cause a change in the relative angle of the measurement axes of the optical systems, which would affect the measured on-axis velocity.

In some variants the mounting bar is made from steel.

According to a further embodiment of the fourth aspect of the invention the mounting bar comprises a passive thermal enclosure comprising a first insulating layer and a second insulating layer of insulation material. The first insulating layer and the second insulating layer of insulation material being arranged to form a cavity between them.

The presence of a passive thermal enclosure further contributes thermal stabilisation of the mounting bar and minimises its deformation over time.

In some variants, the insulating layer is a foam material. In some variants both the first and the second insulating layer have thicknesses in the range of 10 to 50 mm such as 20 mm as such a thickness is a good compromise for providing sufficient insulation, while maintaining a preferred size of the mounting bar.

### SHORT LIST OF THE DRAWINGS

In the following, examples of embodiments are described according to the invention, where:

FIG. 1 is a schematic illustration of the measurement of a surface.

FIG. 2 is a conceptual illustration of an optically rough surface and the relevance of the beam radius.

FIGS. 3A and 3B illustrate the components of an optical system in two different embodiments.

FIG. 4 is a schematic illustration of a plurality of optical systems mounted on a mounting bar.

### DETAILED DESCRIPTION OF THE DRAWINGS

The invention will now be explained in more detail below by means of examples with reference to the accompanying drawings.

The invention may, however, be embodied in different forms than depicted below, and should not be construed as limited to any examples set forth herein. Rather, any examples are provided so that the disclosure will be thorough and complete, and will fully convey the scope of the invention to those skilled in the art. Like reference numerals refer to like elements throughout. Like elements will, thus, not be described in detail with respect to the description of each figure.

FIG. 1 schematically illustrates the method of measuring the axial velocity d (illustrated by a double arrow as it is to be understood that this movement may be in either direction), due to the divergence of a surface 1 under a force F (illustrated as an arrow) in an axial direction relative to an optical system 10.

The optical system 10 comprises a laser source arranged to emit a coherent laser beam 22 in an axial direction such that the laser beam 22 will coincide with the surface 1. The coherent laser beam 22 will upon incidence with the surface 1 be reflected. The part of the reflected light which is reflected on-axis, i.e. in the direction back along the emission axis, is considered the reflected beam 32. The reflected beam 32 is detected by a detector of the optical system 10.

The deflection force F, conceptually illustrated as an arrow in FIG. 1, and the surface 1 move relative to each other in a direction transverse to the axial direction of the laser beam 22 and the reflected beam 32. If there is a divergence of the surface 1, e.g. due to an applied deflection force F or due to a vibrational wave propagating through the material underlying the surface, the velocity d with which the surface 1 diverges will differ depending on the position at the surface 1 where the divergence takes place as the amount the surface diverges will depend on the structural integrity of the material at that position. In some preferred embodiments which will be the examples discussed henceforth, a means of applying a deflection force F is mounted together with the optical system 10 such that the optical system 10 undergoes transversal movement v (illustrated by the arrow v) relative to the surface 1 together with the applied deflection force F for an axial velocity d to be measurable. Due to the transverse movement v and the applied divergence force F, the axial velocity and thus the measured Doppler shift will vary depending on the structural strength under the surface depending on how big the deflection of that surface is at a specific transversal position. Due to the transverse movement speed v and the axial velocity of the divergence d the on-axis, distance L travelled by the laser beam 22 along the axial direction will remain constant. In other embodiments not discussed in further examples, the optical system 10 may remain stationary relative to the surface 1, while only the deflection force F travels in the transverse direction.

As the reflected beam 32 is defined as the part of the reflected light which is on-axis, this light will cause interference with the coherent laser beam 22 due to the axial velocity of the divergence d. This interference may be detected by the optical system 10 and from this measurement it is possible to determine the Doppler frequency. It is understood that only the on-axis reflection is considered the reflected beam 32. Hence, the variation in the on-axis velocity may be measured for optically rough surfaces as they cause diffuse reflection whereby there will be reflection in the axial direction. A specular reflecting surface is not suited as the optical system 10, unless it can be ensured that the reflection matches the position of the detector given the transversal velocity v.

Coaxial measurement of the reflection, i.e. the coherent laser beam 22 and the reflected beam 32 being coaxial, is preferable as measurements are simplified. It is to be understood that in other embodiments the system may be configured to measure a reflected beam 32 which is not coaxial with the emitted coherent laser beam 22, e.g. by having the reflected beam collected at an angle or guided back not via a beam splitter but directed to an adjacently placed detector. The benefits of the optimised beam width are not limited to coaxial measurement.

Knowing the starting position of the optical system 10 relative to the surface 1 and the speed of the transverse movement it is possible to correlate the magnitude of the Doppler frequency shift to a specific position on the surface 1.

The transverse movement v between the optical system 10 and the surface 1 is relative. Hence in some embodiments the optical system 10 may be stationary while the surface 1 is moving. One example of such an embodiment is a conveyor belt, which may continuously move past the optical system 10 which detects at one position while the surface 1 changes either due to a deflection force applied to the conveyer belt or due to vibrations propagating through the conveyor belt. In another embodiment the moving surface may be a part of machinery which rotates, vibrates, or is supposed to translate with a specific frequency, the stationary optical system 10 may in such embodiments be used to determine unintended variations or changes in movement patterns, e.g. due to vibrations, wear, malfunction, or tilted installation.

In other embodiments, the transverse movement v between the optical system 10 and the surface 1 may be caused by the movement of the optical system 10 while the surface 1 is stationary. One example of such an embodiment is the mounting of the optical system 10 on a vehicle, which may drive along the surface the properties which are being measured, e.g. a road or a rail road. In such embodiments, the vehicle may also have a load mounted on board such that a known strain is affecting the surface 1. In such cases the optical system 10 may measure the deflection of the surface 1 caused by the load mounted on the same vehicle as the optical system 10. Such loads may be adjustable or fixed.

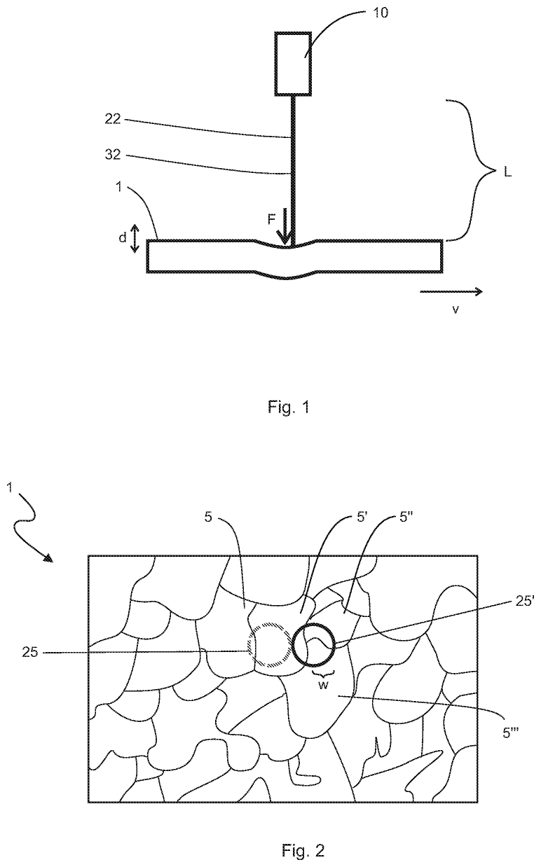

FIG. 2 schematically illustrates a surface 1 which comprises different segments 5,5′,5″. The different segments 5 are simply shown as areas of irregular size, which could for example correspond to different segments of stone or gravel on a road-like surface.

These are, however, only one example, as different structure might for example have a repeating regular pattern, such as the surfaces of a conveyor belt having surface structuring to engineer the coefficient of friction.

On FIG. 2 the laser spot 25 of the laser beam is shown in a simplified manner as a circle illustrating the 1/e² intensity radius, such that the radius of the circle corresponds to the beam radius w according to the invention.

In determining a suitable beam size, two factors are relevant. One factor to consider is the speckle decorrelation also known as speckle boiling. When the surface 1 has moved relative to the optical system by a distance corresponding to the laser spot 25 on the surface 1, it is a new region on the surface 1 which is responsible for the reflection and hence also for the speckle pattern of the reflected light. This is illustrated in FIG. 2 by the shifted laser spot 25′ next to the laser spot 25. The shifted laser spot 25′ is where the laser beam will impinge once the surface 1 has moved twice the beam radius w.

In the marked laser spot 25 three different segments 5′,5″,5″ contribute to the speckle pattern scattered from the surface 1. In the shifted laser spot 25′ only two segments 5,5′ contribute to the scattering of the light off of the surface, and only one of those is the same as for the original laser spot 25. The difference in the speckle pattern of the reflected light due to the change of the structure of the surface 1 will cause an undefined phase change of the Doppler signal causing speckle decorrelation.

Hence, in consideration of the speckle decorrelation it is beneficial to increase the beam radius w.

The other factor to consider for the choice of the beam radius w is that the signal power increases for a smaller radius w as more light is reflected from the surface 1, the increase in signal power further increases the accuracy of the measurement and/or decreases the required power consumption of the laser source.

Hence, in consideration of the signal power it is beneficial to decrease the beam radius W.

The lower limit for the functionality of the optical system and the method is thus governed by the phase noise due to the speckle decorrelation and the beam radius must be at least:

$${w}_{min} = \sqrt{λ \frac{L}{π}}$$

Wherein:
λ is the wavelength of the coherent laser light emitted from the laser source; and
L is the distance from the laser source of the optical system 10 to the surface 1.

It is further noted that this applies to holds for a Gaussian beam profile which may be circular or elliptical. In the case of an elliptical beam, the equation must hold for either of the long or the short radius and may optionally hold for both.

The upper limit is governed by the signal power. The signal power may be adjusted either via decreasing the beam radius or by supplying more power from the laser source.

Hence the upper limit of the radius is primarily governed by practical concerns of the set-up, e.g. the available laser source, cost of supplying power and/or the maximum area of the surface which can be illuminated which may e.g. be limited by distance between wheels of a vehicle under which the optical system is mounted or the width of an examined conveyor belt.

For the preferred practical usage of the optical system and method the upper limit will be 5 times

$$\sqrt{λ \frac{L}{π}} .$$

This strikes a balance between the two factors of speckle decorrelation and the signal power.

As previously discussed, it is known to a skilled person how to arrange the components of the optical system 10 to adjust the beam radius w to be within the preferred range. Once the laser source has been chosen, the wavelength of the emitted coherent light is fixed and the skilled person can subsequently choose the one or more lenses of the lens system and the placement, e.g. the distance between the laser and the beam shaping lens and, if there are multiple lenses, the mutual distance between such lenses, to obtain a beam radius w within the desired range.

In one exemplary embodiment, the optical system may be mounted such that the distance L to the surface is 1.6 m and the wavelength of light emitted by the laser source may be 1550 nm. In this case the beam radius at the surface is at least 0.89 mm.

In another exemplary embodiment the optical system may be mounted such that the distance L to the surface is 1.8 m while using the same wavelength of light emitted by the laser source of 1550 nm. In this case the beam radius at the surface is instead at least 0.94 mm. However, Due to the effects of the measurement environment, however, slight variations in this width may occur throughout the measurement procedure. Thus, in some embodiments it may be beneficial to shape the beam to be larger than the lower limit such that slight variations will not cause the beam radius to drop below the lower limit.

FIGS. 3A and 3B schematically illustrate the components of the optical system 10 for two different embodiments of the invention.

FIG. 3A shows as embodiment of the optical system 10 wherein a polarizing beam splitter 44 is arranged to divide the emitted laser beam 22 and the reflected beam 32 from the on-axis propagation to be directed to the detector 30.

In this embodiment a laser source 20 emits coherent laser light. The emitted laser light is passed through a first optical path 41 in the illustrated embodiment in the form of an optical fibre. In this embodiment the first optical fibre 41 is polarization maintaining such that the light delivered to the polarizing beam splitter 44 maintains its polarization. A lens system 47 is arranged between the polarizing beam splitter 44 and the surface 1 and is configured to control the beam radius on the surface 1 to be larger than the minimum beam radius wₘᵢₙ by falling within the range of beam radii according to the invention. The lens system 47 may comprise a single lens or multiple lenses. The one or more lenses of the lens system 47 may be arranged to provide the intended beam radius based on their position in relation to the emitted laser beam and their curvature.

It is noted that several locations of the lens system 47 relative to the other components of the optical system 10 are possible according to the invention. The lens system 47 may be arranged in the optical path between the polarizing beam splitter 44 and the surface/target 1 as illustrated, or it may be placed between the optical path 41 and the polarizing beam splitter 44 as well as between the polarizing beam splitter 44 and the second optical path 42, or a combination of the above.

The emitted coherent laser light passes the polarizing beam splitter 44 which is arranged to direct the emitted laser beam 22 towards the surface 1 such that the laser beam 22 will coincide with the surface 1 (arrows along the optical paths denotes the direction of travel of the beams). The coherent laser light is reflected from the surface 1 and the reflected beam 32 propagates on-axis back towards the polarizing beam splitter 44.

The polarizing beam splitter 44 directs the reflected beam 32 to a second optical path 43 in the form of an optical fibre, the second optical fibre 43 being polarization maintaining. The second optical fibre 43 guides the reflected light towards a detector 30.

In some preferred embodiments as illustrated in FIG. 3A, the optical system further comprises a bypass optical path 46, in the illustrated embodiment in the form of a bypass optical fibre. The bypass optical path 46 guides a subpart of the emitted laser light directly from the laser source 20 to the detector 30. The light emitted directly from the laser source 20 and the reflected beam 32 interfere within the detector 30 and the Doppler frequency can be determined. Some detectors may not require such a bypass optical path.

In some preferred embodiments comprising a bypass optical path 46, an AOM 50 such as a Bragg-cell may be arranged within that bypass optical path 46 to allow the controlled frequency shifting of the emitted laser light before it enters the detector 30.

The detector 30 may comprise a processing unit for calculating the axial velocity d of the divergence based on the detected Doppler shift and/or the detector may comprise a transmitter for transmitting the recorded signal to an external processing unit wherein the data can be stored and/or subsequent calculations can be made. The processing unit, whether integrated in the optical system or external, may further make calculations to correlate the measured Doppler frequency to the position on the surface 1.

While this embodiment is illustrated with optical fibres as all optical paths it is to be understood that other embodiments with the same working principle may use other waveguides or free space optics to guide the light.

In some variants of the optical system 10, the lens system 47 may be mounted such that the optical system 10 can be calibrated by adjusting the position of the one or more lenses of the lens system 47. For example the one or more lenses of the lens system 47 may be mounted on rails such that they can be translated along such rail, e.g. by a motor. In other embodiments of the optical system 10, the lens system 47 may be mounted such that lenses can be exchanged with other lenses to adjust the configuration for different use cases, e.g. for mounting on different pieces of equipment which would cause the axial distance L to vary. Another way of calibration may be achieved by adjusting the placement of the optical system 10 in relation to the surface.

Such calibration methods may be used in combination or separately. In addition—or as an alternative—mathematical correction of the detected signal may be performed by the on-board or external processing unit based on reference measurements.

FIG. 3B schematically illustrates an alternative arrangement of the optical system 10 wherein a circulator 45 is arranged between the surface 1 and the laser source 20 and detector 30, respectively. The circulator 45 enables the emitted coherent laser beam 22 and the reflected beam 32 to be guided along the same emission and reflection optical path 42 while it is still possible to distinguish the reflected signal at the detector 30. Coherent laser light emitted from the laser source 20 is directed through a first optical path 41 to a first port of the circulator 45 and is then guided towards the surface 1 underlying material via an emission and reflection optical path 42 through the second port. The reflected beam 32 is also collected in the second port of the circulator 45 and then exits the circulator 45 through a third port to traverse the second optical path 43 and reach the detector 30.

In embodiments having a circulator 45, a lens system 47 having one or more lenses is present. The lens system 47 is arranged to ensure that the emitted laser beam is shaped such that the beam radius w on the surface 1 is within the range of the invention. The lens system 47 is arranged between the laser source 20 and the surface 1. In some embodiments the lens system 47 may be arranged between the circulator 45 and the surface 1, for example by placement in the emission and reflection optical path 42 between the circulator 45 and the surface 1. As illustrated, the optical path of the optical system may consist of fibres but in other embodiments other waveguides may be used as may free space optics.

Similarly as to previously described embodiments, the optical system comprising a circulator may have the lens system 47 arranged to be adjustable to enable calibration. Also similarly to previously described embodiments, the optical system may comprise an integrated processing unit and/or a transmitter to allow for storing of measurement and/or computations based on the Doppler frequency.

In some preferred embodiments as illustrated in FIG. 3B the optical system further comprises a bypass optical path 46, in the illustrated embodiment in the form of a bypass optical fibre. The bypass optical path 46 guides a subpart of the emitted laser light directly from the laser source 20 to the detector 30. The light emitted directly from the laser source 20 and the reflected beam 32 interfere within the detector 30 and the Doppler frequency can be determined. Some detectors may not require such a bypass optical path.

Although not illustrated, some preferred embodiments having a circulator and a bypass optical path 46 further comprise an AOM 50, such as a Bragg-cell, arranged in the bypass optical path 46 to allow the controlled shifting of the emitted laser light before it enters the detector 30.

While both the embodiment illustrated in FIG. 3A and in FIG. 3B show configurations where there is coaxial propagation of the coherent laser beam 22 and the reflected beam 32, it is to be understood that in other embodiments according to the invention the propagation needs not be coaxial. The benefits of the invention are also achieved in situations where the laser source 20 and detector 30 are arranged such that the reflected beam 32 is detected at an angle with respect to the coherent laser beam 22.

In all illustrated embodiments, the optical system 10 has been shown as mounted gravitationally above the surface 1 from which the light is reflected. The skilled person, however, would understand that it is also possible to have the relative mounting differently e.g. to measure a vertical surface or having the optical system 10 arranged to measure a plate or a material with a surface 1 gravitationally above it.

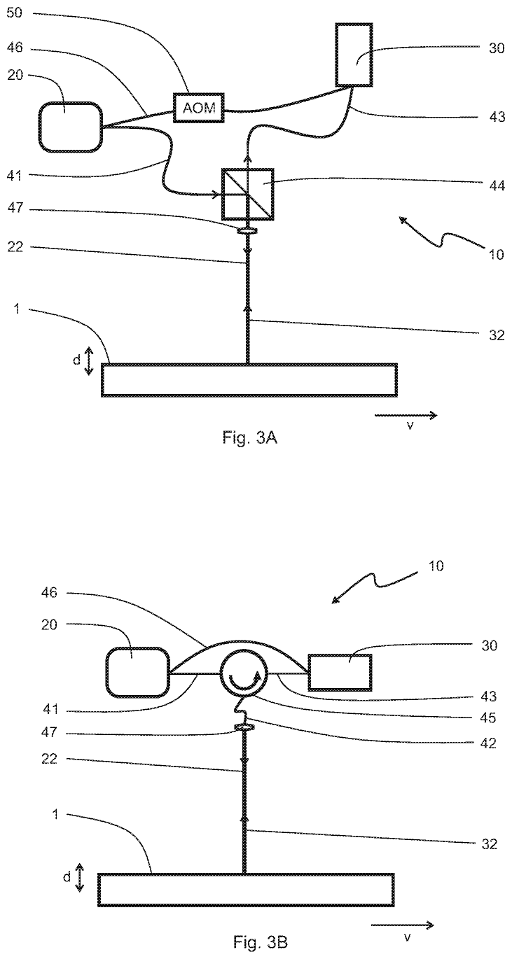

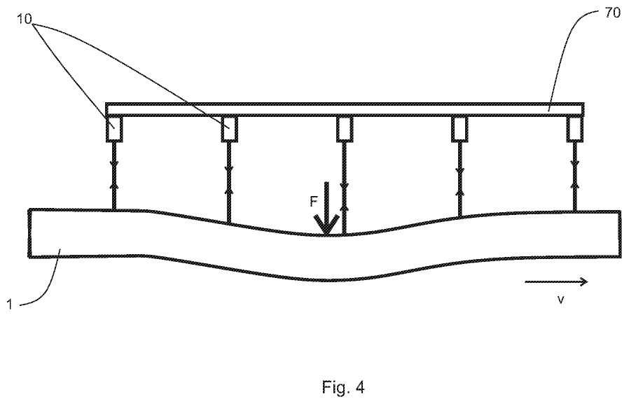

FIG. 4 illustrates the concept of a plurality of optical systems 10 being mounted to a mounting bar 70. Each optical systems 10 fixed to the mounting bar 70 may be of the same type, e.g. having polarizing beam splitter and having their lens systems arranged in the same manner. In other variants, some or all of the optical systems 10 fitted to the same mounting bar 70 may be of different types.

The optical systems 10 may be fitted to the mounting bar 70 evenly distributed across the length of the mounting bar 70, some or all of the optical systems 10 may be clustered or the optical systems 10 may be unevenly distributed based on estimates of where it is most important to measure the divergence for the given surface, e.g. based on the position of an applied deflection force F. In some embodiments, a group of optical systems 10 may be grouped while one or more optical systems 10 may be fitted away from this group, e.g. such that it may function as a reference if the mounting bar 70 is to be used in connection with a load-bearing vehicle causing the deflection be measured by the optical systems.

The mounting bar 70 itself is preferably constructed to minimise the effects of heating from external sources in the environment where the optical systems are mounted and used.

The mounting bar is preferably made from metal. In some embodiments the mounting bar is made from steel.

The shape of the mounting bar may also contribute to the sturdiness and rigidity of the mounting bar 70 during use. In some embodiments the mounting bar 70 may be constructed as a beam with an H-profile. In other embodiments the mounting bar 70 may be constructed as a beam with a C-profile.

In some embodiments, the mounting bar may be constructed with a passive thermal enclosure such that the impact of the heating from the external environment is lessened. Such a passive thermal enclosure may include a hollow having a first insulating layer and a second insulating layer of insulation material.

The above embodiments are exemplary and other components may be added for example to filter the signals, split the delivered and reflected beams, change polarisation or generally shape the laser beam while fall within the scope of the invention.

Below is a list of reference signs used in the detailed description of the present disclosure and in the drawings referred to in the detailed description of the present disclosure.
1 Surface
5, 5′, 5″ Segments
L Axial distance
d Axial velocity
F Deflection Force
v Relative speed in transverse direction
w Beam radius
10 Optical system
25 Laser source
22 Coherent laser beam
25 Laser spot
30 Detector
32 Reflected beam
41 First optical path
42 Emission and reflection optical path
43 Second optical path
44 Polarising beam splitter
45 Circulator
46 Bypass optical path
47 Lens system
50 AOM
70 Mounting bar

1) (canceled)

2) (canceled)

3) (canceled)

4) (canceled)

5) (canceled)

6) (canceled)

7) (canceled)

8) (canceled)

9) (canceled)

10) (canceled)

11) (canceled)

12) A method for optically measuring divergence of a surface in an axial direction at an angle with respect to said surface, said method comprising:
providing an optical system, said optical system comprising a laser source and a detector; emitting a laser beam of coherent light from said laser source of said optical system in said axial direction towards said surface while said surface is moving in a transversal direction relative to said emitted laser beam; said laser beam emitted such that the beam radius on said surface is larger than or equal to
$$\sqrt{λ \frac{L}{π}}$$
wherein λ is the wavelength of the emitted laser beam and L is the distance from the laser source to said surface such as the beam radius on said surface being within a range of
$$\sqrt{λ \frac{L}{π}}$$
to 5 times
$$\sqrt{λ \frac{L}{π}} ;$$
measuring an optical signal of a reflected beam reflected from said surface;
determining the Doppler frequency of the reflected beam;
based on the Doppler frequency determining the movement of said surface in said axial direction.

13) The method according to claim 12, wherein the distance said optical system has travelled in the transverse direction relative to said surface and/or the speed of the relative transverse movement is monitored.

14) The method according to claim 12, wherein said relative movement between said surface and said optical system is due to the movement of a vehicle on which said optical system is mounted along said surface.

15) The method according to claim 12, wherein said relative movement between said surface and said optical system is due to the translation and/or rotation of said surface while said optical system is static.

16) The method according to claim 12, wherein measurement results are transmitted to a data processing unit for storing and/or processing said data.

17) The method according to claim 14, wherein measurement results are transmitted to a data processing unit for storing and/or processing said data.

18) An optical system configured for use in a method of measuring surface divergence based on Doppler frequency measurements, said optical system comprising:
a laser source for emitting coherent light,
a first optical path being arranged to guide coherent light from said laser source and for directing a coherent laser beam towards a surface, said first optical path being polarization maintaining,
a detector, for detecting a reflected beam of light reflected off of said surface,
a second optical path for collecting and guiding said reflected beam to said detector, said second optical path being polarization maintaining,
a polarizing beam splitter arranged between said first optical path and said second optical path for diverting the on-axis reflected beam to said second optical path,
said optical system providing said laser beam with a beam radius being larger than or equal to
$$\sqrt{λ \frac{L}{π}}$$
at the intersection with said surface, such as the beam radius being within a range
$$\sqrt{λ \frac{L}{π}}$$
to 5 times
$$\sqrt{λ \frac{L}{π} .}$$

19) An optical system according to claim 18, comprising a lens system for controlling the focal point of said emitted laser beam such that said beam radius at the intersection of said laser beam and said surface is larger than or equal to
$$\sqrt{λ \frac{L}{π} ,}$$
such as the beam radius being within a range of
$$\sqrt{λ \frac{L}{π}}$$
to 5 times
$$\sqrt{λ \frac{L}{π} .}$$

20) An optical system configured for use in a method of measuring surface divergence based on Doppler frequency measurements, said optical system comprising:
a laser source for emitting coherent light,
a detector, for detecting a reflected beam of light reflected off of a surface,
a first optical path being arranged to guide coherent light from said laser source and for directing a coherent laser beam towards said surface,
a second optical path for collecting and guiding said reflected beam to said detector,
a circulator arranged between said laser source, said detector, and said surface for keeping said emitted coherent light and said collected reflected beam separate; and
said optical system providing said laser beam with a beam radius being larger than or equal to
$$\sqrt{λ \frac{L}{π}}$$
at the intersection with said surface, such as the beam radius being within a range equal to of
$$\sqrt{λ \frac{L}{π}}$$
to 5 times
$$\sqrt{λ \frac{L}{π} .}$$

21) An optical system according to claim 20, comprising a lens system for controlling the focal point of said emitted laser beam such that said beam radius at the intersection of said laser beam and said surface is larger than or equal to
$$\sqrt{λ \frac{L}{π} ,}$$
such as the beam radius being within a range of
$$\sqrt{λ \frac{L}{π}}$$
to 5 times
$$\sqrt{λ \frac{L}{π} .}$$

22) A measurement system configured for use in a method of measuring surface divergence based on Doppler frequency measurements, said measurement system comprising a plurality of optical systems with each of the plurality of optical systems comprising,
a laser source for emitting coherent light,
a first optical path being arranged to guide coherent light from said laser source and for directing a coherent laser beam towards a surface, said first optical path being polarization maintaining,
a detector, for detecting a reflected beam of light reflected off of said surface,
a second optical path for collecting and guiding said reflected beam to said detector, said second optical path being polarization maintaining,
a polarizing beam splitter arranged between said first optical path and said second optical path for diverting the on-axis reflected beam to said second optical path,
said optical system providing said laser beam with a beam radius being larger than or equal to
$$\sqrt{λ \frac{L}{π}}$$
at the intersection with said surface, such as the beam radius being within a range equal to
$$\sqrt{λ \frac{L}{π}}$$
of to 5 times
$$\sqrt{λ \frac{L}{π}} ,$$
wherein the plurality of optical systems are arranged along a mounting bar.

23) A measurement system according to claim 22, wherein each of the plurality of optical systems comprises a lens system for controlling the focal point of said emitted laser beam such that said beam radius at the intersection of said laser beam and said surface is larger than or equal to
$$\sqrt{λ \frac{L}{π}} ,$$
such as the beam radius being within a range of
$$\sqrt{λ \frac{L}{π}}$$
to 5 times
$$\sqrt{λ \frac{L}{π}} .$$

24) A measurement system according to claim 22, wherein the mounting bar comprises a passive thermal enclosure comprising a first insulating layer and a second insulating layer of insulation material, said first insulating layer and said second insulating layer of insulation material being arranged to form a cavity between them.

25) A measurement system according to claim 23, wherein the mounting bar comprises a passive thermal enclosure comprising a first insulating layer and a second insulating layer of insulation material, said first insulating layer and said second insulating layer of insulation material being arranged to form a cavity between them.

26) A measurement system configured for use in a method of measuring surface divergence based on Doppler frequency measurements, said measurement system comprising a plurality of optical systems with each of the plurality of optical systems comprising,
a laser source for emitting coherent light,
a detector, for detecting a reflected beam of light reflected off of a surface,
a first optical path being arranged to guide coherent light from said laser source and for directing a coherent laser beam towards said surface,
a second optical path for collecting and guiding said reflected beam to said detector,
a circulator arranged between said laser source, said detector, and said surface for keeping said emitted coherent light and said collected reflected beam separate; and
said optical system providing said laser beam with a beam radius being larger than or equal to
$$\sqrt{λ \frac{L}{π}}$$
at the intersection with said surface, such as the beam radius being within a range of
$$\sqrt{λ \frac{L}{π}}$$
to 5 times
$$\sqrt{λ \frac{L}{π}} ,$$
wherein the plurality of optical systems are arranged along a mounting bar.

27) A measurement system according to claim 26, wherein the each of the plurality of optical systems comprises a lens system for controlling the focal point of said emitted laser beam such that said beam radius at the intersection of said laser beam and said surface is larger than or equal to
$$\sqrt{λ \frac{L}{π}} ,$$
such as the beam radius being within a range of
$$\sqrt{λ \frac{L}{π}}$$
to 5 times
$$\sqrt{λ \frac{L}{π}} .$$

28) A measurement system according to claim 26, wherein the mounting bar comprises a passive thermal enclosure comprising a first insulating layer and a second insulating layer of insulation material, said first insulating layer and said second insulating layer of insulation material being arranged to form a cavity between them.

29) A measurement system according to claim 27, wherein the mounting bar comprises a passive thermal enclosure comprising a first insulating layer and a second insulating layer of insulation material, said first insulating layer and said second insulating layer of insulation material being arranged to form a cavity between them.
